(19) United States
(12) Patent Application Publication
(10) Pub. No.: US 2009/0246571 A1
(43) Pub. Date: Oct. 1, 2009

(54) DETERMINATION OF THE LAMBDA VALUE OF REFORMATE WITH THE AID OF A FUEL CELL

(75) Inventors: Stefan Käding, Zerrenthin (DE); Matthias Boltze, Neuendorf (DE); Michael Rozumek, Neubrandenburg (DE); Manfred Pfalzgraf, Herrsching (DE); Andreas Engl, Munich (DE); Beate Bleeker, Munich (DE); Michael Süssl, Munich (DE); Markus Bedenbecker, Gauting (DE)

Correspondence Address: DICKINSON WRIGHT PLLC, 1875 Eye Street, NW, Suite 1200, WASHINGTON, DC, 20006, US

(73) Assignee: ENERDAY GMBH, Stockdorf (DE)

(21) Appl. No.: 12/302,447

(22) PCT Filed: Jun. 12, 2007
(86) PCT No.: PCT/DE2007/001037

§ 371 Date: Nov. 25, 2008

(30) Foreign Application Priority Data
Jun. 27, 2006 (DE) 10 2006 029 451.3

(51) Int. Cl. H01M 8/04; H01M 2/02

(52) U.S. Cl. 429/17; 429/34; 429/22

(57) ABSTRACT

The invention relates to a process for determining the lambda value (λ_{actual}) of reformate provided for supply to a fuel cell stack, in which the no-load voltage across at least one fuel cell element is detected and evaluated for determining the lambda value (λ_{actual}). In accordance with the invention it is provided for that the at least one fuel cell element is a terminal fuel cell element of the fuel cell stack exclusively provided for sensing, and the voltage provided for at least one consumer can be picked off across the remaining fuel cell elements of the fuel cell stack. The invention relates furthermore to a process for lambda control of a reformer, a device for determining the lambda value, as well as to a system comprising a reformer for reacting at least fuel and air into reformate, and a fuel cell stack which is connected with the reformer for receiving reformate therefrom, the reformer being lambda-controlled.

The invention relates to a process for determining the lambda value of reformate provided for supply to a fuel cell stack, in which the no-load voltage across at least one fuel cell element is detected and evaluated for determining the lambda value.

Furthermore, the invention relates to a process for lambda control of a reformer for reacting at least fuel and air into reformate provided for supply to a fuel cell stack.

The invention also relates to a device for determining the lambda value of reformate provided for supply to a fuel cell stack, the device having means suitable for detecting and evaluating the no-load voltage across at least one fuel cell element for determining the lambda value.

Moreover, the invention relates to a system comprising a reformer for reacting at least fuel and air into reformate and a fuel cell stack which is supplied with reformate by the reformer, the reformer being lambda-controlled.

The generic processes, devices and systems are used in conjunction with the conversion of chemical energy into electrical energy. For this purpose, fuel and air, preferably in the form of a fuel/air mixture, are supplied to the reformer. The reaction of the fuel with atmospheric oxygen takes place in the reformer, preferably the process of partial oxidation being carried out.

The reformate produced in this way is then supplied to a fuel cell or a fuel cell stack, electrical energy being released by controlled reaction of hydrogen as a component of the reformate, and oxygen.

As already mentioned, the reformer can be designed such that the process of partial oxidation is carried out in order to produce reformate. In this case, when using diesel as fuel, it is especially useful to carry out preliminary reactions before partial oxidation. In this way, long-chain diesel molecules can be reacted into short-chain molecules with a “cold flame” to the ultimate benefit of reformer operation. In general, the reaction zone of the reformer is supplied with a gas mixture which is reacted into H₂ and CO. Another component of the reformate is N₂ from the air, and depending on the air ratio and the temperature, optionally, CO₂, H₂O and CH₄. In normal operation, the fuel mass flow is adjusted according to the required output, and the air mass flow is adjusted to a lambda value or an air ratio in the region of λ=0.4. The reforming reaction can be monitored by different sensors, for example, temperature sensors and gas sensors.

In addition to the process of partial oxidation, it is likewise possible to carry out autothermal reforming. The process of partial oxidation, in contrast to autothermal reforming, is induced by oxygen being substoichiometrically supplied. For example, the mixture has an air ratio of λ=0.4. The partial oxidation is exothermal so that unwanted heating of the reformer can pose a problem. Furthermore, partial oxidation tends to increased soot formation. To prevent soot formation, the air ratio λ can be selected bigger and/or some of the oxygen used for oxidation made available by water vapor. Since oxidation proceeds endothermally with water vapor, it is possible to adjust the ratio between the fuel, oxygen and water vapor such that altogether heat is neither released nor heat consumed. The autothermal reforming which is achieved in this way therefore eliminates the problems of soot formation and undesirable overheating of the reformer.

It is likewise possible for other steps of gas treatment to take place following oxidation in the reformer, and especially methanation can be implemented downstream of partial oxidation.

One current fuel cell system is, for example, a proton exchange membrane (PEM) system which can typically be operated at operating temperatures between room temperature and roughly 100° C. Due to the low operating temperatures, this fuel cell type is often used for mobile applications, for example, in motor vehicles.

Known furthermore are high temperature fuel cells, so-called solid oxide fuel cell (SOFC) systems. These systems work, for example, in the temperature region of roughly 800° C., a solid electrolyte (solid oxide) being capable of handling the transport of oxygen ions. The advantage of these high temperature fuel cells compared to PEM systems is especially their heavy mechanical and chemical duty compatibility.

One application for fuel cells in conjunction with generic systems includes, besides stationary applications, especially applications in the motor vehicle domain, for example as an auxiliary power unit (APU).

To determine the lambda value of reformate, in prior art, a sensor (lambda probe) provided in the output area of the reformer is often used to measure the oxygen concentration. This constitutes an additional material expenditure which is associated with high costs. Furthermore, tightness problems and/or temperature problems can occur.

Known from German patent DE 103 58 933 A1 are generic processes, devices and systems in which a no-load voltage across at least one fuel cell element is sensed and the result correspondingly evaluated to obtain an actual lambda value for use in controlling it to a lambda setpoint. The no-load voltage across a fuel cell element is a function of the momentary operating conditions to a lesser degree than a voltage during energy output. A no-load voltage could be detected, for example, by measuring it solely in operating phases in which the consumers draw no current from the corresponding fuel cell element. Furthermore, a no-load voltage could also be detected, for example, by briefly separating the consumers from the corresponding fuel cell element; but this would disrupt smooth operation of consumers. On top of this, sampling a voltage to be sensed from just one or a few fuel cell elements adds to production and wiring complications.

The invention is based on the object of sophisticating generic processes, devices and systems such that the lambda value can now be determined friendly to assembly and operation.

This object is achieved by the features of the independent claims.

Advantageous aspects and further embodiments of the invention read from the dependent claims.

The process in accordance with the invention for determining the lambda value is based on the generic prior art in that at least one fuel cell element is a terminal fuel cell element of the fuel cell stack provided exclusively for sensing and the voltage provided for at least one consumer can be picked off across the remaining fuel cell elements of the fuel cell stack. Now, by detecting the no-load voltage across a terminal fuel cell element engineering the wiring is simplified because accessing terminal fuel cell elements is much simpler than a fuel cell element from the middle of the fuel cell stack. In addition, making use of the fuel cell element exclusively for sensing no longer disrupts smooth, continued operation. In this arrangement this now permits determining the voltage of the fuel cell element provided for sensing in any operating condition of the fuel cell stack or of the consumer, this voltage always corresponding to a no-load voltage of the fuel cell element due to it being employed exclusively for sensing.

Furthermore, for the process in accordance with the invention, for determining the lambda value, it is preferred that the lambda value can be deduced via the Nernst equation. This is possible since the no-load voltage of the fuel cell element provided for sensing obeys the Nernst equation.

In addition, it is of advantage for the process in accordance with the invention that the lambda value is obtained furthermore as a function of the temperature of the at least one fuel cell element. Since when determining the lambda value, particularly when determining it via the Nernst equation, the sensed voltage greatly depends on the temperature involved, a more precise value is now achievable by including the temperature in determining the lambda value.

The process of the invention for lambda control of a reformer is based on the generic prior art in that lambda control is carried out on the basis of lambda values but departs in that these values are now determined with the process of the invention. Here too, determining lambda values is now much more efficient than in prior art.

The device in accordance with the invention for determining the lambda value is based on generic prior art, but that now at least one fuel cell element is a terminal fuel cell element of the fuel cell stack provided exclusively for sensing and the voltage provided for at least one consumer can be picked off across the remaining fuel cell elements of the fuel cell stack. This achieves consequently the advantages obtained in conjunction with the process as described above.

It is preferred also in the case of the device in accordance with the invention that the means provided are suitable to deduce the lambda value via the Nernst equation. This now permits obtaining the lambda value by direct evaluation of the Nernst equation, via suitable truth tables or by any other way as suggested to the person skilled in the art.

It is furthermore of advantage to design the device in accordance with the invention so that a temperature sensor is provided with which the temperature of the at least one fuel cell element can be sensed, the result being supplied to means enabling the lambda value to be determined as a function of the temperature of the at least one fuel cell element. Since when determining the lambda value, particularly when determining it via the Nernst equation, the sensed voltage greatly depends on the temperature involved, a more precise value is now achievable by including the temperature in determining the lambda value.

The system in accordance with the invention is based on generic prior art except that now, for implementing lambda control, it comprises the device in accordance with the invention for determining the lambda value.

Preferred embodiments of the invention are explained below by way of example with reference to the accompanying drawings, in which:

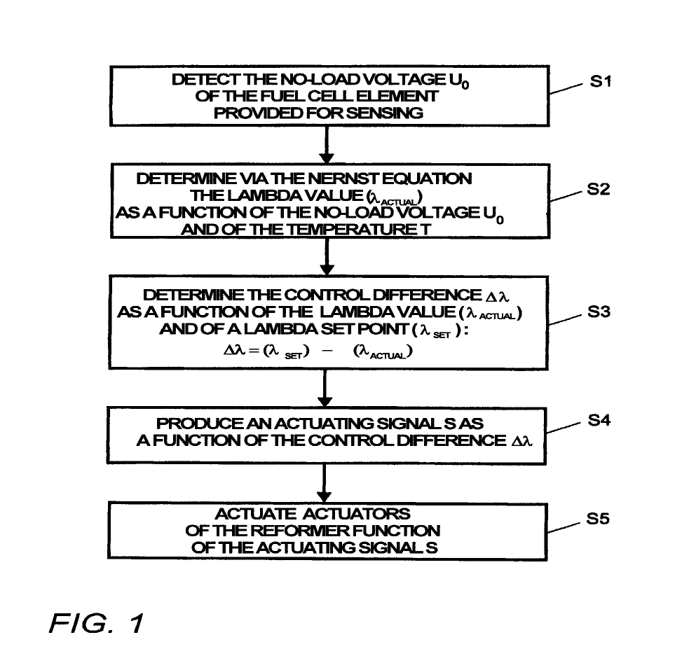

FIG. 1 is a flow chart which illustrates one embodiment of the process in accordance with the invention;

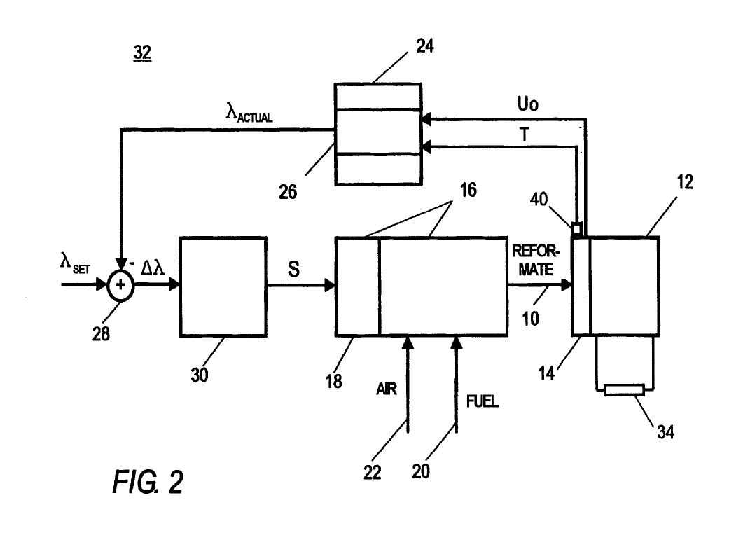

FIG. 2 is a block diagram which illustrates one embodiment of the device and system in accordance with the invention; and

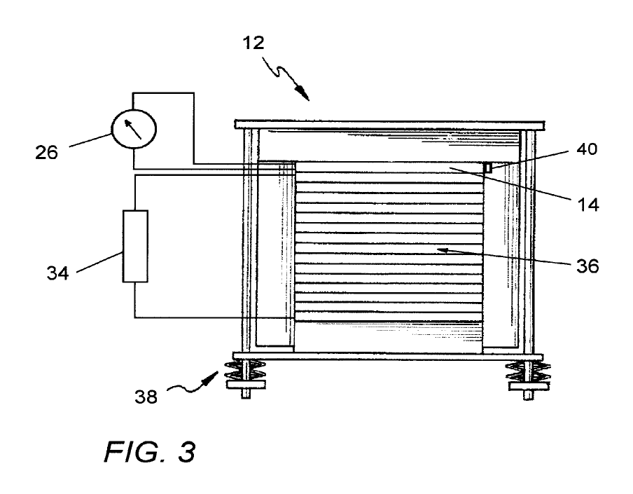

FIG. 3 is a diagrammatic representation illustrating one embodiment of a fuel cell stack.

Referring now to FIG. 1 there is illustrated, by the steps S1 to S2, one embodiment of the process of the invention for determining the lambda value, while steps S1 to S5 show one embodiment of the process in accordance with the invention for lambda control of a reformer.

In accordance with the process as shown, one fuel cell element of a fuel cell stack comprising a plurality of fuel cell elements is provided exclusively for sensing, i.e. it not supplying consumers but only instruments for determining the measurement values. For this purpose this fuel cell element is electrically insulated from the other fuel cell elements to thus permit use as a lambda sensor. The remaining fuel cell elements are connected in series to thus furnish a higher voltage for application to one or more consumers. It will be appreciated that other embodiments are just as possible in which more than just one fuel cell element is provided exclusively for sensing, interconnected in series to furnish a higher measurement voltage.

In step S1 the no-load voltage U₀ of the fuel cell element provided for sensing is detected by means with which the person skilled in the art is familiar, working as analog and/or digital means. Since this fuel cell element has no consumer supply, its voltage as detected corresponds to a no-load voltage thereof in all and any operating conditions of the consumer or fuel cell stack.

In step S2, via the Nernst equation the lambda value λ_{actual} is determined as a function of the no-load voltage U₀ and the actual temperature T of the fuel cell element provided for sensing, this being possible since the no-load voltage U₀ of a fuel cell element provided for sensing obeys the Nernst equation.

As an alternative in step S2 the lambda value λ_{actual} can be determined via the Nernst equation as a function of the no-load voltage U₀, ignoring the temperature of the fuel cell element provided for sensing.

In step S3 the control difference Δλ is determined as a function of the lambda value λ_{actual} and a lambda setpoint λₛₑₜ via the relation Δλ=Δₛₑₜ−Δ_{actual}.

Then, in step S4, an actuating signal S is produced as a function of the control difference Δλ.

In step S5 at least one actuator is actuated depending on the actuating signal S. One or more actuators can be assigned especially to the reformer, and, for example, can vary the supply of air and fuel. If there are several actuators, the actuating signal S preferably contains a plurality of data suitable for respective triggering of an actuator.

Referring now to FIG. 2 there is illustrated a block diagram which illustrates both one embodiment of the device in accordance with the invention and also one embodiment of the system of the invention. The device 24 in accordance with the invention can be implemented by hardware and/or software as known to the person skilled in the art and is designed for determining the lambda value λ_{actual} of the reformate 10. The reformate 10 is produced by a reformer 16 and is supplied to a fuel cell stack 12. The fuel cell stack 12 comprises a plurality of fuel cell elements, of which, in the illustrated case, one fuel cell element 14 is provided exclusively for sensing so that this fuel cell element 14 permanently furnishes a no-load voltage U₀, even then, it is to be noted when the consumers 34 have a high power demand. The device 24 in accordance with the invention comprises means 26 which evaluate the no-load voltage U₀ of the fuel cell element 14 for determining the lambda value λ_{actual} and which evaluate the actual temperature of the fuel cell element 14 as sensed by means of a temperature sensor 40. In this arrangement, the temperature sensor 40 is optional, i.e. the lambda value λ_{actual} can also be determined without taking into account the temperature as sensed by means of a temperature sensor 40. The means 26 determine the lambda value λ_{actual} preferably via the Nernst equation. The means provided for determining the lambda value can be realized by analog or digital circuits as known to the person skilled in the art, particularly by hardware with the cooperation of suitable software.

The device 24 in accordance with the invention is a component of a system 32 of the invention and which, in addition to the device 24, furthermore, comprises a reformer 16 for reacting fuel 20 and air 22 into reformate 10 and a fuel cell stack 12 which is supplied by the reformer 16 with reformate 10 and which, in addition to the no-load voltage U₀ of the fuel cell element 14, delivers an output voltage for a consumer 34. The illustrated system furthermore comprises an adder 28 which produces a control difference Δλ from the lambda setpoint λₛₑₜ and the actual lambda value λ_{actual}. This control difference Δλ is supplied to a controller 30 which is likewise assigned to the system 32 and which outputs one or more suitable actuating signals S depending on the control difference Δλ In the illustrated case the actuating signal S is supplied to an actuator 18 which is a component of the reformer 16. The actuator 18 can be used, for example, to manage the supply of fuel 20 and/or air 22.

Referring now to FIG. 3 there is illustrated diagrammatically one embodiment of a fuel cell stack. The fuel cell stack 12 comprises a plurality of fuel cell elements 14, 36 held in place by a clamping frame 38. The fuel cell elements 14, 36 convert reformate and oxidant into electrical energy by ways and means as known generally. For this purpose the fuel cell elements 14, 36 are shaped as plates featuring two through-holes which form two passageways by the fuel cell elements being stacked, via which the reformate can be supplied and the anode exhaust gas discharged. Provided among the fuel cell elements is at least one terminal fuel cell element 14 exclusively for sensing and which is electrically insulated from the other fuel cell elements 36. The terminal fuel cell element 14 is electrically connected to the means 26 for evaluating the no-load voltage U₀ and optionally for evaluating its temperature T. The two outermost fuel cell elements of the fuel cell stack 12 may serve as the terminal fuel cell element 14. It is just as possible that a plurality, i.e. a train of outermost terminal fuel cell elements may be provided exclusively for sensing. Electrically connected to the remaining fuel cell elements 36 is a consumer, they being connected in series for this purpose so as to furnish a higher voltage. In this arrangement, the voltage for the consumer 34 is picked off from the outermost of the remaining fuel cell elements 36. It is to be noted that the term consumer as used in this context covers all and any combinations of one or more consumers connected in series and/or in parallel. The temperature sensor 40 for sensing the temperature of the fuel cell element 14 is in contact with the fuel cell element 14. When the fuel cell element 14 is configured identical to the other fuel cell elements 36, the temperature sensor can be bonded to the outer side of the fuel cell element 14, for instance. As an alternative to this, the temperature sensor 40 may be arranged in a recess of the fuel cell element 14 or in a recess of the clamping frame 38. The temperature sensor 40 is connected to the means 26 by wiring (not shown).

In operation the operating condition of the fuel cell stack 12 varies as a function of the power requirement of the consumer. At the terminal fuel cell element 14 the means 26 can always sense the no-load voltage U₀ of this fuel cell element 14, irrespective of the power requirement of the consumers 34 and the operating mode of the fuel cell stack 12.

It is understood that the features of the invention disclosed in the above description, in the drawings and in the claims may be essential both individually and also in any combination for achieving the invention.

### LIST OF REFERENCE NUMERALS

1 reformate
2 fuel cell stack
14 sensing fuel cell element
16 reformer
18 actuator
20 fuel
22 air
24 device for determining the lambda value
26 means for evaluating the no-load voltage and temperature
28 adder
30 system
34 consumer
36 fuel cell elements provided for consumers
38 clamping frame
40 temperature sensor

1. A process for determining the lambda value (λ_{actual}) of reformate provided for supply to a fuel cell stack, in which the no-load voltage (U₀) across at least one fuel cell element is detected and evaluated for determining the lambda value (λ_{actual}), characterized in that the at least one fuel cell element is a terminal fuel cell element of the fuel cell stack provided exclusively for sensing and the voltage provided for at least one consumer can be picked off across the remaining fuel cell elements of the fuel cell stack.

2. The process of claim 1, characterized in that the lambda value (λ_{actual}) is determined via the Nernst equation.

3. The process of claim 1, characterized in that the lambda value (λ_{actual}) is sensed furthermore as a function of the temperature (T) of the at least one fuel cell element.

4. A process for lambda control of a reformer for reacting at least fuel and air into reformate to be supplied to a fuel cell stack characterized in that lambda control is implemented on the basis of the lambda values (λ_{actual}) determined by the process of claim 1.

5. A device for determining the lambda value (λ_{actual}) of reformate provided for supply to a fuel cell stack, comprising means suitable for detecting and evaluating the no-load voltage (U₀) across at least one fuel cell element for determining the lambda value (λ_{actual}), characterized in that the at least one fuel cell element is a terminal fuel cell element of the fuel cell stack provided exclusively for sensing and the voltage provided for at least one consumer can be picked off across the remaining fuel cell elements of the fuel cell stack.

6. The device of claim 5, characterized in that the means are suitable for deducing the lambda value (λ_{actual}) via the Nernst equation.

7. The device of claim 5, characterized in that a temperature sensor is provided with which the temperature of the at least one fuel cell element an be sensed, the result being supplied to means enabling the lambda value (λ_{actual}) to be determined as a function of the temperature (T) of the at least one fuel cell element.

8. A system (32) comprising a reformer for reacting at least fuel and air into reformate and a fuel cell stack which is connected with the reformer for receiving reformate therefrom, the reformer being lambda-controlled, characterized in that for implementing lambda control the system comprises a device of claim 5.
